(19) United States
(12) Patent Application Publication
(10) Pub. No.: US 2009/0055722 A1
(43) Pub. Date: Feb. 26, 2009

(54) CUSTOMIZABLE CERTIFICATE DESIGN AND METHOD OF USE

(76) Inventors: Monica Eorgoff, Chicago, IL (US); Edwin B. Watts, Chicago, IL (US)

Correspondence Address: ROSENBAUM & ASSOCIATES, P.C., 650 DUNDEE ROAD, SUITE #380, NORTHBROOK, IL, 60062, US

(21) Appl. No.: 11/843,547

(22) Filed: Aug. 22, 2007

(51) Int. Cl. G06F 15/00

(52) U.S. Cl. 715/211

(57) ABSTRACT

The invention is a method for creating a customizable certificate design comprising a word patterned background with words or phrases related to a special event interdispersed with user inputted words or phrases and a central emblem.

### BACKGROUND OF THE INVENTION

The field of the invention is electronic communication and design, and more specifically a method for customizable certificate design.

In the electronic-design services, currently users are limited to the options available for producing genuine greeting cards with customizable background layouts. The services provide no real outlet for creativity in the background layout, which is typically a carbon copy of a designs provided by website hosts. The present invention addresses these problems, as well as others.

### SUMMARY OF THE INVENTION

The invention is a method of customizing a certificate design comprising: accessing a memory device having a database of customizable certificate design layouts, wherein the customizable certificate design layout comprises a word patterned background and a central emblem, wherein the word patterned background includes a plurality of lines with repeating words or phrases related to a special event interdispersed with user inputted words or phrases, and the central emblem includes at least one piece of data inputted by the user and the words or phrases related to a special event; creating a customized certificate design from user inputted words interdispersed between words or phrases related to a special event in the word patterned background and from user inputted words in the central emblem; providing a user with the option of saving the customizable certificate design at the user's computer, e-mailing the customizable certificate design.

Additional advantages of the invention will be set forth in part in the description which follows, and in part will be obvious from the description, or may be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE FIGURES

The accompanying drawings, which are incorporated in and constitute a part of this specification, illustrate alternative embodiments of the invention and together with the description, serve to explain the principles of the invention.

FIG. 1 is one embodiment of the customizable certificate design.

FIG. 2 is a flow chart depicting general steps and interfaces between an application software to an Internet application, server, and local personal computer.

FIG. 3 is a flow chart depicting steps generally taken in accordance with the present invention.

FIG. 4 is a flow chart depicting the steps taken to create the word patterned background and central emblem

FIG. 5 is a flow chart depicting the steps for a profanity check and spell check for user inputted words.

FIG. 6 is a flow chart depicting the steps for modifying the customizable certificate design.

FIG. 7 is an example web page for entering user inputted words.

FIG. 8 is one embodiment of the customizable certificate design.

FIG. 9 is an example web page for altering the color background of the customizable certificate design.

### DETAILED DESCRIPTION OF THE PREFERRED EMBODIMENTS

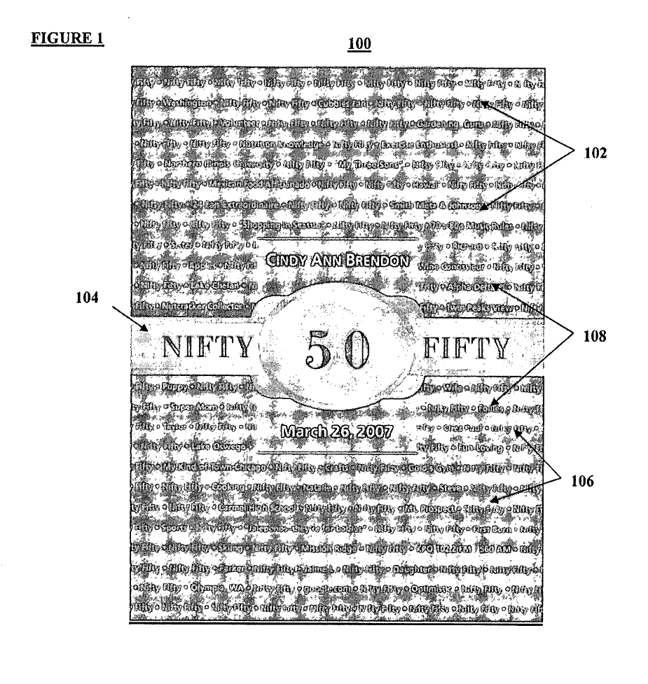

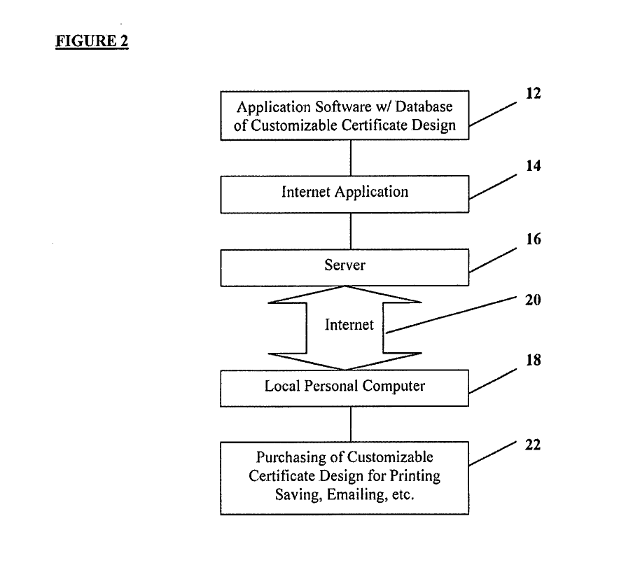

Generally speaking, the invention is a customizable certificate design 100 and method comprising a word patterned background with words or phrases related to a special event interdispersed with user inputted words or phrases, as shown in FIG. 1. The present invention utilizes an application software 12, which is a memory device that includes a database of customizable certificate design 100 layouts in the form of templates and the like, as shown in FIG. 2. The templates have a predefined layout and arrangement for a word patterned background 102 and a central emblem 104. The word patterned background 102 includes a repeating word or phrase 106 related to the special event, occasion, or announcement. A user then enters interdispersed words or phrases 108 to be placed in the word patterned background 102. The customizable certificate designs 100 can then be printed, saved, emailed, or sent to local vendor for personalized formatting of the design on merchandise, greeting cards, and the like.

In FIG. 2, in one embodiment of the invention, an Internet application 14 runs the application software 12. The Internet application interacts with a server system 16 which runs the Internet application 14 to connect to a local personal computer 18 through the Internet 20. The local personal computer 18 interfaces with the remote server system 16 through the Internet 20. The Internet is a global computer network infrastructure supporting the World Wide Web (“WWW”). The WWW service allows a server 16 computer system to send graphical web pages of information to a remote client computer system. The remote client computer system can then display the Web pages. Each Web page or computer of the WWW is uniquely identifiable by a Uniform Resource Locator (“URL”). The view a specific Web page, a client computer system specifies the URL for that Web page in a request, i.e. Hyper Text Transfer Protocol, (“HTTP”). The request is forward to the Web server that supports that Web page. When that Web page server receives the request, it sends that Web page to the client computer system. When the client computer system receives that Web page, it displays the Web page using a browser. In another embodiment of the invention, application software can publish the website. A programming language is employed to select for graphics, text, and animations to create the customizable certificate design 100 selection, customize graphic elements and colors of the customizable certificate design 100, create a pop-up window to enter names or a phrases that are applied using a submit button. The webpage acts as an interactive interface for the internet.

One of the most commonly used tools for communication over the Internet is a software application known as a browser. Examples of currently available browsers include Microsoft Internet Explorer, Mozilla Firefox, and Apple Safari. A browser is a software application that runs on a local computer and provides a user-friendly environment in which a user can interact with a server system via a graphical user interface which allows the user of the local computer to submit various requests or responses. A browser requests, transfers, and displays information that is stored as files on the Internet. A browser is typically run on a personal computer with an operating system such as Windows 95, 98, 2000, XP, ME, Vista, or Linux, or MAC OS.

Requests submitted by the local computer are processed by the server system which responds to the request over the Internet by forwarding a request status and the requested information. One of the most commonly accessed resources on the Internet is web-sites or web pages. Web-sites are interactive resources or interfaces that provide an end user with a graphical interface for either viewing or downloading. A web-site may include a number of graphically displayable pages of information that are linked together, typically with hypertext or hyperlinks. The contents of a web-site can be created using a computer language such as Hypertext Markup Language (HTML) or Extensible Markup Language (XML), Adobe Flash Software, and the like. The document or page is text file coded with embedded predefined keywords or tags which are used by the server system in locating information and responding to the local computer's request. Once the end user has viewed the web page, the user can interact with the web page by entering information in a dialog box or clicking on a button, for example.

In another embodiment of the invention, a non-Internet application can also be implemented comprising a local memory device containing the database of customizable certificate design layouts and other necessary components for authorizing printing, saving, or sending the design to a local vender. The local memory device can be a DVD, CD-ROM, or other electronic device connected to the local personal computer 18, such as through a local PC BUS, or port such as a Universal Serial Bus port.

The local personal computer 18 interfaces with either the server or local memory device in order to create the desired customizable certificate design. The server or local memory includes a database of numerous customizable certificate design layouts for the user to view and select. The customizable certificate design can be purchased 22 for printing at local printer, emailing to recipient, saving on local personal computer, or sent to local vendor for printing or further merchandise processing. The customizable certificate design can be incorporated as a design for a variety of merchandise, including but not limited to, shirts, cups, hats, cards, folders, stickers, sweaters, shoes, and the like.

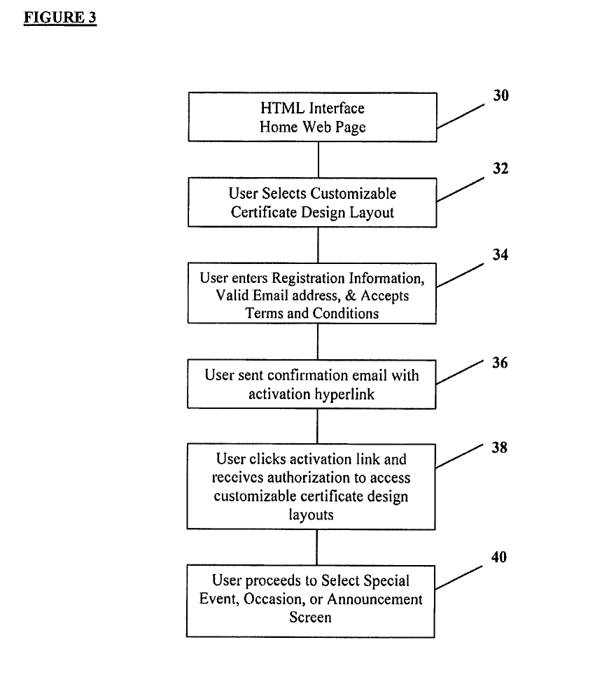

As shown in FIG. 3, the customizable certificate design layouts are in an HTML interface 30, where the user connects to the home web page. The home web page would have information about the customizable certificate design, such as electronic confirmation, selection of different customizable certificate designs, User Registration, Pricing, Delivery Options, Terms and Conditions, Privacy Statement, Account Information and Status, Customer Service, and the like. The user makes selections 32 to determine which particular customizable certificate design 100 layout in the HTML interface 30. The customizable certificate design layouts will include a watermark if the user attempts to save the image from the web page or print the customizable certificate design without purchasing. Once a user selects a customizable certificate design, the user will be prompted to 34 register the user's name, email address, and accept the Terms and Conditions of accessing the customizable certificate design. The user may select a username and password to obtain certification to use and access the customizable certificate designs. Once the user reads and clicks to accept the Terms and Conditions of using the customizable certificate design and provide the user's name and email address, a confirmation email 36 will be sent to the user's email address. The confirmation email will contain a hyperlink that activates the user's account, and allows the user to proceed to select a special event, occasion, or announcement screen 40 once the user clicks the activation hyperlink.

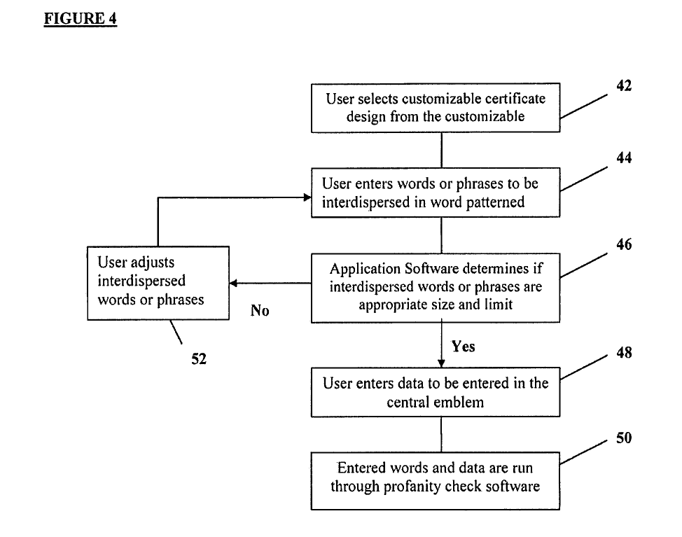

As shown in FIG. 4, after the user selects the special event, occasion, or announcement, the user is directed to a sample customizable certificate design screen 42 displays a variety of customizable certificate designs 100 for special events, occasions, announcements, and the like. The customizable certificate design screen 42 includes hyperlinks to the individual customizable certificate designs. The special events, occasions, announcements and the like can include, but not limited to, birthdays, anniversaries, weddings, graduation, baby showers, bridal showers, baptism, bar mitzvahs, congratulatory wishes on retirements, get well cards, religious holidays, Miss You, Friendship cards, and traditional Holiday cards such as Christmas, Hanukkah, Easter, Valentines' Day, Halloween, or any other Holiday. Each type of special events, occasion, announcements and the like will have more cards that user can choose by selecting the special event, occasion, or announcement, which leads them to the special event, occasion, and announcement screen 40. Each customizable certificate design comprises a word patterned background 102 including a repeating word or phrase 106 related to the special event, occasion, or announcement. The repeating word or phrase 106 related to the special event may also be displayed in the central emblem 104. For example, if the user selects the 50^{th} Birthday as the customizable certificate design, the phrase “Nifty-Fifty” would be repeating in the word patterned background 102 of the customizable certificate design 100 and also displayed in the central emblem 104. The user then enters 44 words or phrases 108 to be interdispersed in the word patterned background. The interdispersed words or phrases 108 in the word patterned background 102 may be limited to 1 to 10 words, as to fit the interdispersed words or phrases 108 in the word patterned background. The application software 46 can determine if the number of words or the length of the interdispersed words or phrases 108 is too long to be interdispersed in the word patterned background 102. If the user inputted interdispersed words 108 are not of an appropriate length, the user will be prompted to enter 52 adjusted interdispersed words or phrases.

Optionally, the user can enter 48 words or phrases that will be displayed with the central emblem 104. For example, the user can enter a recipient's name and date of birth to be displayed on the central emblem 102. The user enters words or phrases 108 to be interdispersed between the repeating words related to the special event in the word patterned background 102. The interdispersed words or phrases 108 can be interdispersed in any pattern or order in the word patterned background. The user may have the option to select where the interdispersed words or phrases 108 are placed in the word patterned background 102. The words or data will be run through a software program to check for profanity 50. The software profanity program can be turned off if the user verifies their age being over 18 years old, such as by credit card verification.

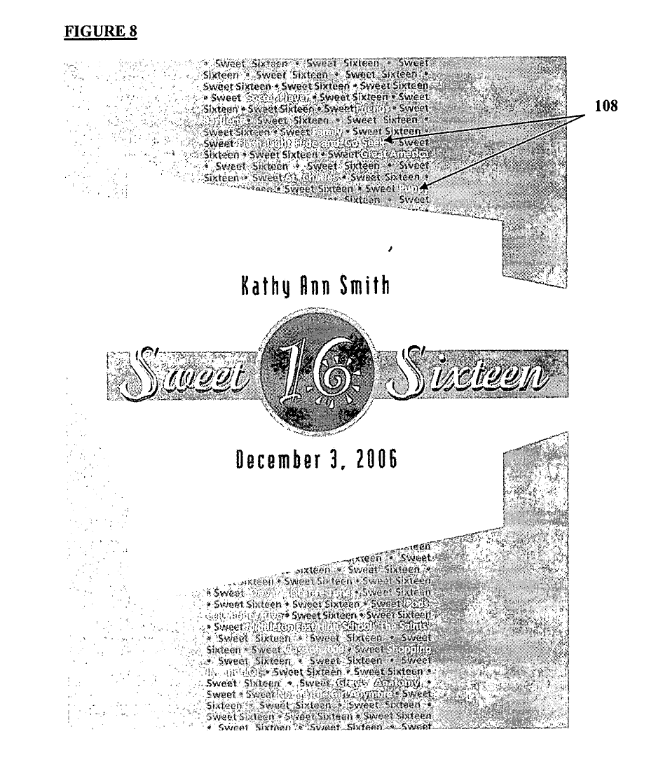

In one embodiment of the invention, the word patterned background 102 includes at least 20 lines of the repeating word of phrase relating to the special event, occasion, or announcement. In one embodiment of the invention, the interdispersed words or phrases 108 inputted by the user may be limited according to the special event, occasion, or announcement. For example, if the special occasion is a 16^{th} Birthday, the user may be limited to sixteen interdispersed words or phrases 108, such as shown in FIG. 8. In one embodiment of the invention, the orientation of the word patterned background is substantially horizontal. Alternatively, the orientation of the word patterned background can be diagonal, vertical, a circular pattern, a polygonal pattern, a pattern identifiable and related to the special event, occasion, or announcement

In one embodiment of the invention, the repeating word or phrase 106 in the word patterned background 102 can be included in a central emblem 104. The central emblem 104 overlaps the word patterned background and can also include user input information, such as the gift receiver's name and other information. In one embodiment of the invention, the central emblem 104 comprises at least one piece of user inputted information. Alternatively, the central emblem 104 comprises no more than two pieces of user inputted information, so as to not overwhelm the word patterned background. For aesthetic purposes, the user inputted information on the central emblem 104 can be selected in a different font, size, and style than the font, size, and style of the word patterned background. The central emblem 104 may also include a background overlapping the word patterned background 102. The user may select an option of placing the central emblem 104 at any location on the customizable certificate design.

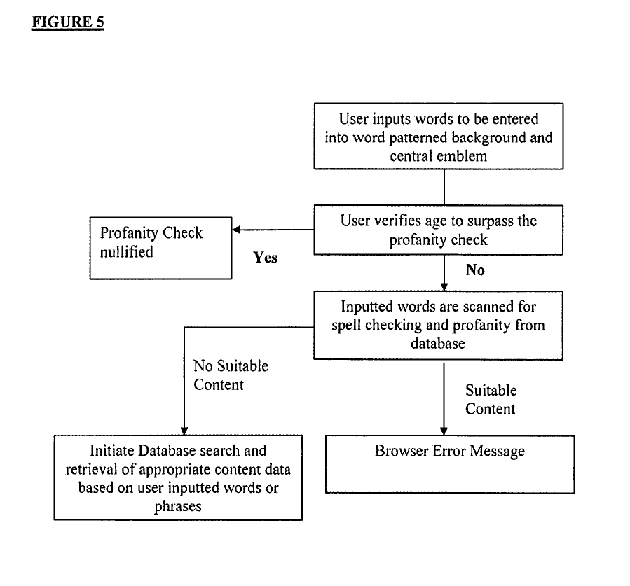

When the user selects the Submit button, the words or phrases entered by the user are run through a profanity and spell check software program 48 in the Internet application, as shown in FIG. 5. The profanity check may be disabled if the user verifies a specified age. If the user's age is not verified, then the profanity check software program ensures that the words or phrases entered by the user are appropriate content to be printed by a vendor and the spell check ensures that the user has not misspelled any user inputted words. If the words or phrases are suitable for printing and the user accepts or refuses all recommended spell checks, the words will be entered into the word patterned background according to the specifications which the user selects, i.e. randomly entered, sequentially entered, group or cluster entered.

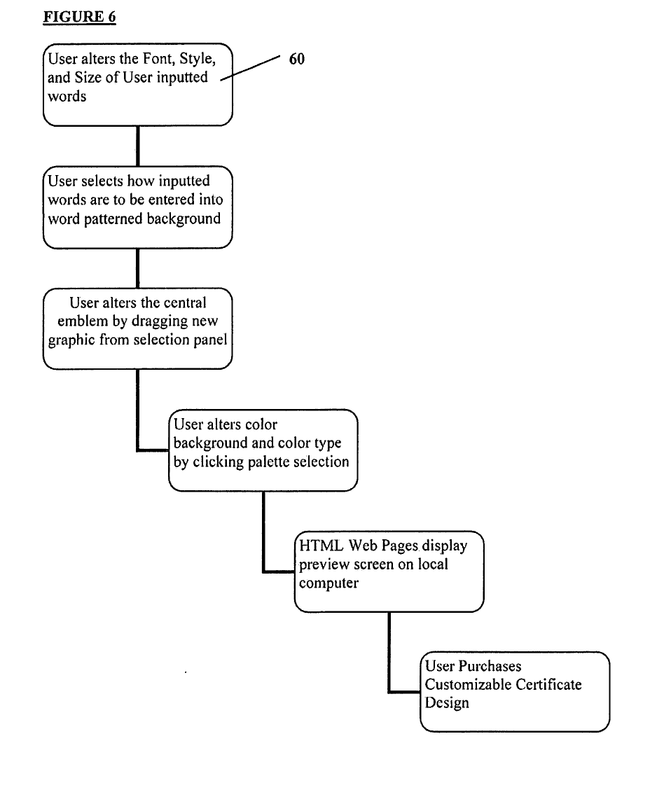

Once the user inputted words have passed the profanity check software, the user may select a variety of options to modify the text of the word patterned background and the central emblem, as shown in FIG. 6. The user has the option to select 60 various fonts, colors, and text styles for the words or phrases to be entered in the word patterned background and central emblem. The user can alter the central emblem by dragging a new graphic from the selection panel or by uploading a picture from the local personal computer. The user can alter the color background and color type by clicking a palette selection displayed on the webpage. The color of the user inputted words or phrases into the word patterned background is a different color than the repeating word or phrase related to the special event, occasion, or announcement, as to provide a contrast to the repeating words or phrases related to the special event, occasion, or announcement. The user inputted words or phrases can be randomly entered into the word patterned background, sequentially entered into the word patterned background, or entered by groups or clusters into the word patterned background. In one embodiment of the invention, the user can select the number of words or phrases to be inputted in the word patterned background. For example, if the user selects the 50^{th} birthday customizable certificate design with the “Nifty-Fifty”.

Then a preview screen displays the customizable certificate design with the user inputted words in the word patterned background interdispersed between the words or phrases related to the special event, occasion, or announcement. The user then has the option to verify or change the customizable certificate design. The user will have various options to purchase the customizable certificate design including printing the customizable certificate design at the local computer system, emailing the customizable certificate design to a recipient, saving the customizable certificate design on the user's local computer system, sending the customizable certificate design to printing vendor, or textile producer. If the user selects to purchase the customizable certificate design by sending the customizable certificate design to a textile vendor, the customizable certificate design can be imprinted on shirts, sweaters, cups, ornamental devices, frames, and the like.

When the user selects to pay for the, the user will be given the final tally of the cost based on the delivery method and number copies, etc. The user purchases the customizable certificate design 100 by traditional electronic shopping cart routine for internet purchase transactions. The user is transferred to a secure e-commerce web page and the user inputs credit card purchase information. When complete, the user is emailed a receipt for the transaction and instructions for obtaining the customizable certificate design 100.

Upon completing the credit card transaction, the customizable certificate design 100 is locked and saved in an online archive, where a user is able to revisit the website and log on by user ID and password and access the personalized customizable certificate design. The user then has the option to order more copies of the personalized customizable certificate design, or alter the design to make a new customizable certificate design.

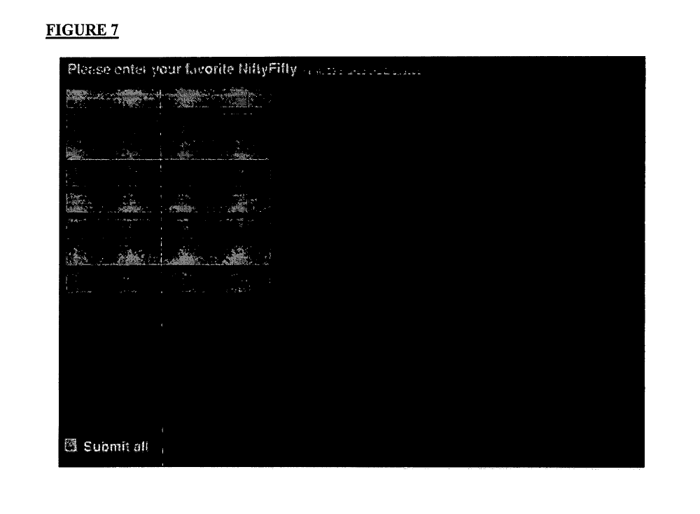

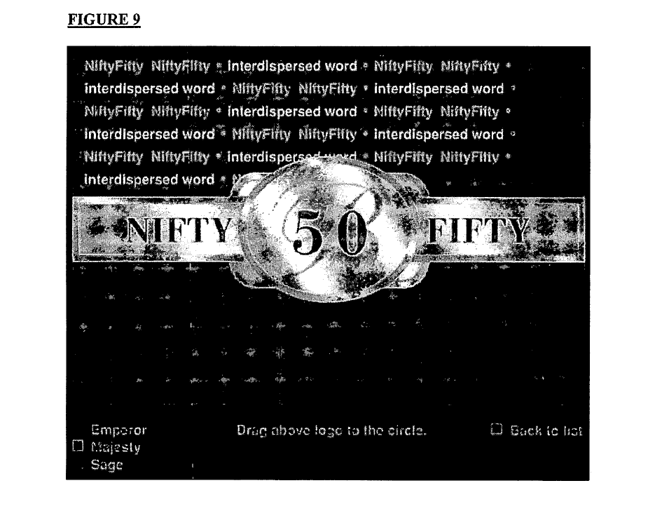

FIG. 7 is an example web page for the user to input words or phrases to be interdispersed in the word patterned background. FIG. 9 is an example web page or interface when the interdispersed words or phrases are interdispersed in the word patterned background.

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method of customizing a certificate design comprising:
a. accessing a memory device having a database of customizable certificate design layouts, wherein the customizable certificate design layout comprises a word patterned background and a central emblem, and the word patterned background includes a plurality of lines with repeating words or phrases related to a special event;
b. prompting a user to input words or phrase interdispersed in the word patterned background; and
c. creating a customized certificate design from user inputted words or phrases interdispersed in the word patterned background.

2. The method of claim 1, wherein the creating step further comprises the step of selecting the central emblem and prompting the user to input words in the central emblem.

3. The method of claim 1, further comprising the step of prompting the user to enter payment information for the customizable certificate design.

4. The method of claim 1, further comprising the step of providing a user with the option of saving the customizable certificate design at the user's computer, printing the customizable certificate design, electronically forwarding the customizable certificate design to a designated recipient, or mailing the customizable certificate design.

5. The method of claim 1, further comprising the step of prompting the user to preview the customizable certificate design to approve or edit the user inputted words or phrases interdispersed in the word patterned background.

6. The method of claim 1, further comprising the step of placing the customizable certificate design in an addressed, stamped envelope and mailing the customizable certificate design to a recipient on a date specified by the user.

7. A method for customizing a certificate design comprising:
a. maintaining a network server with a database of customizable certificate design layouts, wherein the customizable certificate design layout comprises a word patterned background and a central emblem, wherein the word patterned background includes a plurality of lines with repeating words or phrases related to a special event interdispersed with user inputted words or phrases, and the central emblem includes at least one piece of data inputted by the user and the words or phrases related to a special event;
b. receiving data identifying one of the customizable certificate design layouts;
c. receiving data defining user inputted words or phrases to be interdispersed in the word patterned background; and
d. allowing the user to purchase the customizable certificate design.

8. The method of claim 7, further comprising allowing the user to preview and edit the customizable certificate design.

9. The method of claim 7, further comprising the step of sending the customizable certificate design.

10. The method of claim 9, wherein the sending step comprises providing the user the option of saving the customizable certificate design at the user's computer, printing the customizable certificate design, electronically forwarding the customizable certificate design to a designated recipient, or mailing the customizable certificate design.

11. The method of claim 7, further comprising the step of placing the customizable certificate design in an addressed, stamped envelope and mailed to the recipient on a date specified by the user.

12. A method for creating a customizable certificate design, comprising the steps of:
a. interconnecting a central database and an interactive interface;
b. displaying a menu of graphic information on the interface from which a user can select a customizable certificate design including a word patterned background;
c. prompting the user to enter user inputted words or phrases to be interdispersed in the word patterned background through the interface;
d. creating the customizable certificate design with user inputted words interdispersed in the word patterned background;
e. sending the customizable certificate design to the user.

13. The method of claim 12, wherein the prompting step further comprises the step of selecting a central emblem to be placed in the customizable certificate design and prompting the user to input words in the central emblem.

14. The method of claim 12, further comprising the step of prompting the user to enter payment information for the customizable certificate design.

15. The method of claim 12, wherein the sending step comprises providing the user the option of saving the customizable certificate design at the user's computer, printing the customizable certificate design, electronically forwarding the customizable certificate design to a designated recipient, or mailing the customizable certificate design.

16. The method of claim 12, further comprising the step of prompting the user to preview the customizable certificate design to approve or edit the user inputted words or phrases interdispersed in the word patterned background.

17. The method of claim 12, further comprising the step of placing the customizable certificate design in an addressed, stamped envelope and mailed to the recipient on a date specified by the user.
